(19) United States
(12) Patent Application Publication
(10) Pub. No.: US 2017/0273455 A1
(43) Pub. Date: Sep. 28, 2017

(54) MULTIPLE SOCKET OUTLET AND ELECTRICALLY ADJUSTABLE TABLE SYSTEM

(71) Applicant: LOGICDATA Electronic & Software Entwicklungs GmbH, Deutschlandsberg (AT)

(72) Inventor: Stefan LUKAS, Preding (AT)

(73) Assignee: LOGICDATA Electronic & Software Entwicklungs GmbH, Deutschlandsberg (AT)

(21) Appl. No.: 15/503,699

(22) PCT Filed: Jul. 15, 2015
(86) PCT No.: PCT/EP2015/066180

§ 371 Date: Feb. 13, 2017

(30) Foreign Application Priority Data
Aug. 14, 2014 (DE) 10 2014 111 626.7

(51) Int. Cl. A47B 21/06; H01R 13/66; A47B 9/04; H01R 25/00; H01R 13/72

(52) U.S. Cl. CPC A47B 21/06; H01R 25/006; H01R 13/72; H01R 25/003; A47B 9/04; H01R 13/6675

(57) ABSTRACT

A multiple socket outlet (100) for an electrically adjustable table system is provided with a power supply unit (50) for the provision of a DC supply voltage for the table system from a mains AC voltage. The multiple socket outlet (100) forms an integrated unit together with the power supply unit (50).

### BACKGROUND OF THE INVENTION

The present disclosure relates to a multiple socket outlet for an electrically adjustable table system as well as an electrically adjustable table system having such a multiple socket outlet.

In electrically height-adjustable tables, it is known to use a low voltage for actuating corresponding drives or servomotors. A power supply unit is required for generating the low voltage, which converts the mains voltage into the respective low voltage. For example, such a power supply unit can be integrated in a control that controls the power distribution between the drives. Alternatively, such a power supply unit can also be formed separately so that the voltage is supplied to an operating part assuming power distribution to the servomotors.

In some of such conventional implementations, it is disadvantageous that a power cable is to be used between the power supply unit and the power supply. This results in additional cabling work to be required. Furthermore, the bottom side of such a height-adjustable table is less organized since usually an additional power cable is required for the supply of the workplace in any case. Thus, even two or more cable supply lines to the table are necessary and visible in conventional solutions.

In other conventional designs, the separate power supply unit is designed as a power supply plug, which is plugged into a multiple socket outlet or multiple socket mounted below the table, for example. However, this comes with the disadvantage that a high structure is created, thus limiting the legroom below the table.

### SUMMARY OF THE INVENTION

The present disclosure provides an improved cabling concept for electrically adjustable table systems.

The improved cabling concept is based upon the idea of combining a multiple socket outlet, which is required for a table anyway, with a power supply unit, which provides a supply voltage for an electrically adjustable table system, in such a way that the multiple socket outlet forms an integrated unit together with the power supply unit. As a result, the cabling effort of the table system can be reduced. Furthermore, the mounting effort is significantly reduced when compared to conventional solutions. Moreover, the appearance of a bottom side of such a table can be improved.

Multiple socket outlets mays also be known as power strip, extension block, power board, power bar, plug board, trailing gang, trailing socket, plug bar, trailer lead and by many other variations. A multiple socket outlet is a block of electrical sockets that attaches to the end of a flexible cable (typically with a mains plug on the other end), allowing multiple electrical devices to be powered from a single electrical socket.

Here and in the following, the term “integrated unit” particularly refers to the fact that the combination of multiple socket outlet and power supply unit can be processed and installed as an individual uniform module. Here, integration is effected both in technical and in optical terms.

Thus, in one embodiment of the improved cabling concept, a multiple socket outlet for an electrically adjustable table system having a power supply unit is proposed, which serves to provide a DC supply voltage for the table system from a mains AC voltage, wherein the multiple socket outlet forms an integrated unit together with the power supply unit.

According to the improved cabling concept, there are basically two possibilities for forming the integrated unit. In a first possibility, the power supply unit is arranged in a separate housing of the power supply unit, which can be connected into the integrated unit together with a housing of the multiple socket outlet. In another embodiment, the power supply unit is integrated in a housing of the multiple socket outlet.

In the generally separatably designed embodiment, the power supply unit is arranged in a separate housing of the power supply unit. This housing of the power supply unit can be fastened to the multiple socket outlet in such a way that the housing of the power supply unit and the housing of the multiple socket outlet form the integrated unit.

For example, the housing of the power supply unit and the housing of the multiple socket outlet comprise respective mechanical connection elements and respective electric connection elements for the transmission of the mains AC voltage. For example, the mechanical connection elements may ensure that the two housings can be connected to one another in a form-fit or almost form-fit manner so that the appearance of the integrated unit is created or emphasized. The mains AC voltage present in the multiple socket outlet is transmitted to the electronics of the power supply unit via the electrical connection elements for generating the DC supply voltage.

The mechanical and electrical connection elements can also be combinable with one another in various configurations. For example, latch or snap elements may also be provided on a plug element for the transmission of the mains AC voltage, the latch or snap elements establishing the mechanical connection. Preferably, the mechanical connection elements are formed from the same material as the housings, from plastic material, for example.

Preferably, the power supply housing can be fastened at one side of the housing of the multiple socket outlet where no power plug sockets are provided. In other words, the conventionally provided customary sockets of the multiple socket outlet are not used or reserved for the electric connection of the power supply unit, so that the original function of the multiple socket outlet is maintained without limitation.

Further preferably, the plugging of the power supply unit or the housing of power supply unit to the multiple socket outlet is effected with a plug format that deviates from the format of a customary power plug. The customary power plug formats are well known and differ from one another, for example depending on the country that they are used in.

For example, the power supply unit is designed as a switching power supply unit regardless of whether it is integrated in a housing of a power supply unit or directly in the housing of the multiple socket outlet. Besides the higher energy efficiency, this also provides the advantage of a smaller construction size, in particular when compared to conventional transformer power supply units, which may still be used according to the improved cabling concept.

The DC supply voltage may be a low voltage in the range of approximately 20V to 40V that can be directly used for the supply of direct current (DC) drives. Besides this DC supply voltage, the power supply unit is also capable of outputting other voltages, such as lower voltages in the range of approximately 5V, which can be used for the supply of a control electronics or the like. This low voltage can be generated with low power, for example, in particular when compared to a required motor power.

In some electrically adjustable table systems, intelligent motors can be used, for example, which have a control electronics integrated directly at the drive besides the actual drive. Such intelligent drives usually use the available DC supply voltage for operating the respective electric motor, wherein actuation is effected via separate control signals. The electric motors are formed as brushless DC, BLDC for short, motors, for example.

Such motors are connected to a bus system of the table system, for example, wherein both the required DC supply voltage and the control signals for the individual drives are transmitted via the bus system. The control signals are available to all members connected to the bus system, but are evaluated and implemented only by the members addressed via the control signals.

Accordingly, in some embodiments of a multiple socket outlet according to the improved cabling concept, the DC supply voltage is provided via a bus port via which the power supply unit can be connected to a bus system of the table system. For example, in such an embodiment, the power supply unit is configured to control functions of the multiple socket outlet on the basis of bus control signals received via the bus port. To that end, the power supply unit comprises additional electronics, for example, which is configured to receive and evaluate the bus control signals from the bus system. Depending on the bus control signals, for example one or multiple of the sockets of the multiple socket outlet can be switched on and off. As a result, switching functions for lamps or other electric consumers can be integrated in a control of the table system.

In another embodiment, in which the power supply unit comprises a bus port, the multiple socket outlet further comprises a radio receiver for receiving radio control signals, depending on which functions of the multiple socket outlet are controlled. Additionally or as an alternative, control signals for the table system can be provided to the bus system depending on the received radio control signals. Such a radio receiver may be designed as a proprietary high frequency receiver, for example. However, it is also possible that the radio receiver is operated according to a general radio standard such as WLAN or Bluetooth or the like.

One embodiment of an electrically adjustable table system according to the improved cabling concept is based upon an embodiment of the multiple socket outlet having a bus port, as described above. The table system comprises a table, at least one electric drive for adjusting the table, an operating part, a bus system, to which the at least one drive and the operating part are connected, and the multiple socket outlet, which is connected to the bus system via the bus port of the socket.

Such a cabling system is characterized by low cabling effort and an easy start-up.

For example, the at least one electric drive serves for height adjustment of the table, wherein a second electric drive may also be provided to that end, so that a distinct drive is provided on every table foot or table leg, respectively. Instead for height adjustment, the electric drive can also be used for adjusting an inclination angle of a table plate of the table. Other adjustment options are not excluded, of course.

The electric drive(s) is/are connected to the bus system to be able to effect adjustment of the table in a simplified manner, as described above. For example, this takes place by means of the DC supply voltage present on the bus system, which is provided by the multiple socket outlet and the power supply unit thereof, and on the basis of bus control commands or signals that are generated by the operating part. Of course, further elements can be connected to the bus system, such as sensors of various types. For example, pressure or force sensors can be connected, which measure a load of the table. This can be used, inter alia, for known crush protection measures or the like.

In a further developed embodiment, the table system further comprises at least one additional table with at least one further electric drive for the adjustment of the at least one additional table. The at least one further electric drive is also connected to the bus system. The additional table may naturally also comprise more than one electric drive. Thus, one or multiple independent electric drives are provided for each of the tables of the table system, the drives capable of assuming the power required for an adjustment process from the bus system. This power is provided by the power supply unit of the multiple socket outlet.

The two tables, or the respective tables, if more tables are comprised by the table system, can be operated individually by a common operating part. However, it is also possible that multiple operating parts are connected to the bus system to provide a distinct operating part to every or almost every table.

An output power of the power supply unit can be adapted to the required power of the electric drives, so that all drives connected to the bus system can be supplied simultaneously by one single power supply unit.

In one embodiment, the at least one electric drive of the one table and the at least one further electric drive of the at least one further table are configured to indicate a distinct adjustment process to the bus system and to prevent a proper adjustment process when receiving a signal from the bus system about an adjustment process of a drive of the other respective table. In a corresponding operating mode of a table system having multiple tables, it can thus be ensured that in each case only one table is adjusted at a time, while the other one or multiple remaining table(s) are blocked in terms of adjustment. This enables that the effective power requirement of the drives of the entire table system is lower than the theoretical power requirement of the drives taken together at any time.

Accordingly, in such a table system, the output power of the power supply unit is dimensioned to be lower than a sum of rated input powers of the electric drives connected to the bus system, for example. This may lead to cost reductions in the production of the power supply unit or the multiple socket outlet, respectively.

The improved cabling concept will hereinafter be explained by multiple exemplary embodiments by means of Figures. Here, like reference numerals indicate elements or components that have equivalent functions. As far as elements or components correspond one another in terms of their functions, description thereof will not be repeated in every following figure.

### BRIEF DESCRIPTION OF THE DRAWINGS

The figures show in:

FIG. 1 one embodiment of a multiple socket outlet,

FIG. 2 another embodiment of a multiple socket outlet,

FIG. 3 one embodiment of an adapter for a power supply unit according to FIG. 2,

FIG. 4 one embodiment of a table system, and

FIG. 5 another embodiment of a table system.

### DETAILED DESCRIPTION

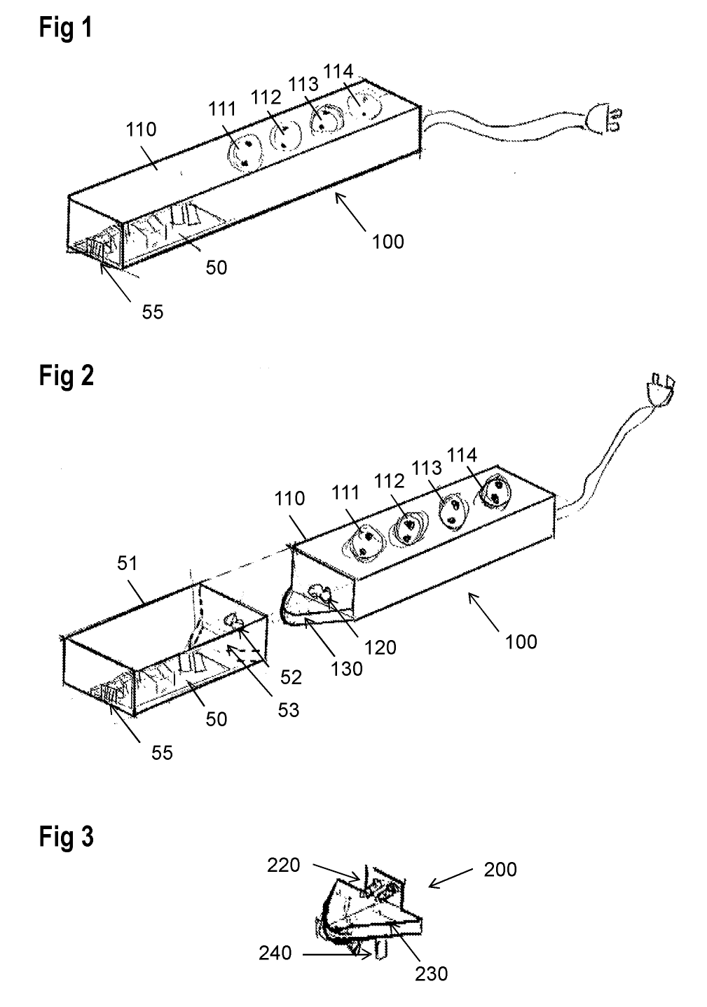

FIG. 1 shows an embodiment of a multiple socket outlet 100 for an electrically adjustable table system according to the improved cabling concept. The multiple socket outlet 100 comprises a housing 110, in which four sockets 111, 112, 113, 114 for power plugs are provided by way of example. The multiple socket outlet 100 can be connected to an outlet via a power cable illustrated by way of example. With the elements described above, the multiple socket outlet 100 allows using its conventional functions, namely the provision of a connection to the power network for multiple electric devices or appliances having standardized power plugs. The multiple socket outlet is connected to an outlet via the power cable and supplies all sockets with power through the internal parallel circuit. Thus, it acts as a distributor, in contrast to a pure extension cable.

In the housing 110 of the multiple socket outlet 100, additionally a power supply unit 50 is provided, which is capable of providing a DC supply voltage for an electrically adjustable table system from the mains AC voltage present in the multiple socket outlet. To that end, the power supply unit 50 comprises a port 55, on which the DC supply voltage can be tapped. Preferably, the power supply unit 50 is designed as a switched mode power supply unit, since this way, power supply units having a lower form factor can be achieved, which can be integrated in the housing 110 in a more simple manner due to their size. For example, the port 55 is designed as a bus port, by means of which the power supply unit can be connected to a bus system not shown here.

Due to the integration of the power supply unit 50 into the housing 110, the power supply unit 50 and the multiple socket outlet form an integrated unit. This allows for the multiple socket outlet 100 to be mounted to a table or to a table system in a simpler manner, since only one unit, namely the multiple socket outlet 100, needs to be fastened to a table. A conventional multiple socket outlet is usually present in table systems anyway, in particular in working tables, so that the multiple socket outlet 100 according to the improved cabling concept can take the place of a conventional multiple socket outlet. It is to be noted that the illustrated number of four sockets is merely exemplary, and can be designed larger or even smaller with only two or three sockets.

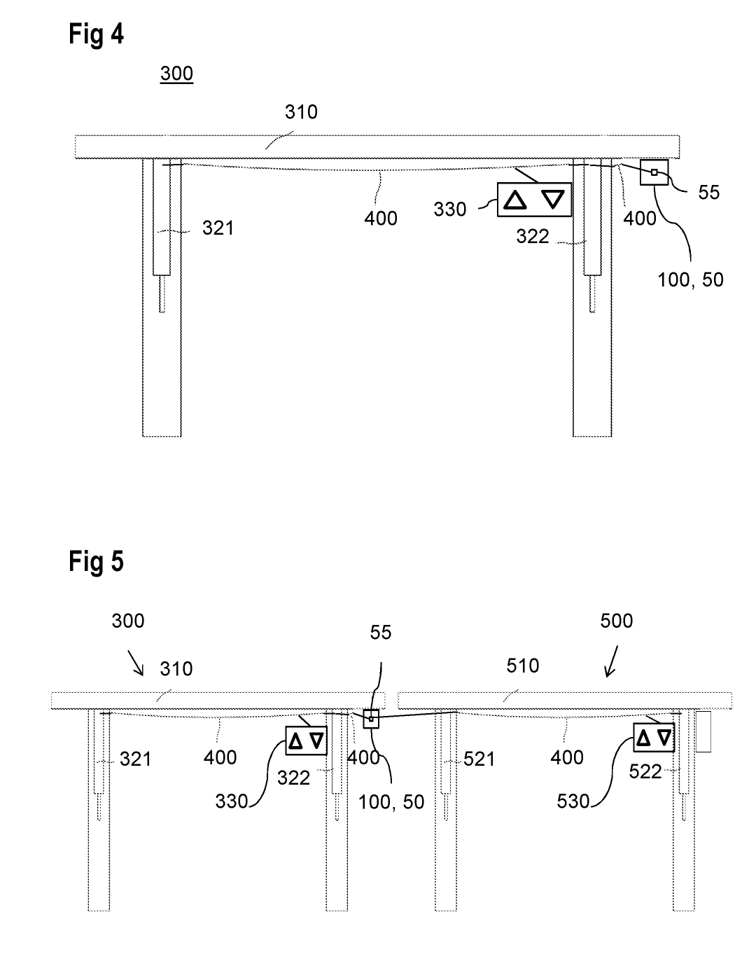

The DC supply voltage provided by the power supply unit 50 at the port 55 can be used by an electric drive of an adjustable table system in order to fulfil the power of the electric motor required for adjustment. However, this shall be explained in greater detail below in conjunction with FIGS. 4 and 5.

FIG. 2 shows another embodiment of a multiple plug according to the improved cabling concept, which is similar to the embodiment illustrated in FIG. 1. However, in contrast to FIG. 1, a distinct housing 51 of the power supply unit is provided for the power supply unit 50, which can be fastened to the multiple socket outlet 100 in a pluggable manner in such a way that the housing 51 of the power supply unit and the housing 110 of the multiple socket outlet 100 form an integrated unit. To that end, in the illustrated embodiment, the power supply housing 51 and the housing 110 have mechanic connection elements 53, 130, via which is effected mechanical coupling of the two housings 51, 110. In addition, respective connection elements 52, 120 are provided in the housing 51 of the power supply unit and in the housing 110, via which elements the mains AC voltage from the multiple socket outlet 110 can be transmitted to the power supply unit 50.

For example, the mechanical connection element 130 of the multiple socket outlet 100 is provided as an element formed as a flat protrusion, which can be guided into a respective recess 53 provided to that end when being plugged together with the power supply housing 51. Latch or snap elements can also be provided here. When the two housings 51, 110 are plugged together accordingly, the required electric connection is established also via the electric connection elements 52, 120. Of course, the electric connection elements 52, 120 are designed in such a way that there is no risk for a user to come into contact with the mains AC voltage even in the not-plugged state of the two housings 51, 110.

Thus, in the plugged state, the housing 51 of the power supply unit and the housing 110 of the multiple socket outlet 100 also form an integrated unit, comparable to the embodiment illustrated in FIG. 1.

The embodiment of the mechanical and electric connection elements illustrated in FIG. 2 is merely exemplary and can be replaced by other functionally equivalent elements. In this case, in particular shape and position of the connection elements can be varied.

In the illustrated embodiment, the housing 51 of the power supply unit is mounted in a direct longitudinal extension of the housing 110 of the multiple socket outlet 100. This is particularly advantageous since none of the sockets 111 to 114 is covered and thus made useless. Furthermore, the construction height of the integrated unit is not changed alone in relation to the multiple socket outlet 100. As a result, the possibility of a simple and space-saving installation of such a multiple socket outlet below a table or a table plate remains.

Instead of the longitudinal extension of the shape of the multiple socket outlet 100, as shown in FIG. 2, the housing 51 of the power supply unit could alternatively also be mounted laterally at the housing 110 of the multiple socket outlet 100, wherein the position of the connection elements 52, 53, 120, 130 is of course displaced. Even in such a configuration, the advantage of a low construction height of the integrated unit is maintained.

In a power supply unit, which is designed as illustrated in FIG. 2, there is another option for the supply of the mains voltage, when the housing 51 of the power supply unit is not directly connected to the multiple socket outlet.

To that end, FIG. 3 shows an exemplary embodiment of a corresponding adapter 200, by means of which the power supply unit 50 can be operated even without the multiple socket outlet 100 of specific design. For example, such an adapter comprises a mechanical connection element 230, which may engage the recess 53 in analogy to the connection element 130 of the multiple socket outlet 100. Accordingly, an electric connection element 220 is also provided in the adapter 200, which engages the electric connection element 52. Finally, the electric connection to the power grid is provided by corresponding conductive pins 240, which can be inserted into a conventional outlet. The design of the pins 240 can of course be made dependent on the intended place of application and the standard for power plugs used there.

As an alternative to the adapter 200, the power supply unit 50 can be connected to the power network via a power cable as well, wherein one side of the power cable has a design that fits to the electric connection elements 52.

Due to the fact that the power supply unit 50 according to FIG. 2 can also be used with the adapter 200 of FIG. 3 or a suitable power cable together with a conventional outlet, flexibility and application range of the power supply unit is increased.

FIG. 4 shows an embodiment of an electrically adjustable table system with a table 300, which comprises a height-adjustable table plate 310, for example. An electric drive 321, 322 is provided in each of the two table legs shown by way of example. Furthermore, the table comprises an operating element 330. An integrated unit of a multiple socket outlet 100 and power supply unit 50 according to one of the embodiments of FIG. 1 or 2 is attached below the table plate 310, for example in the right area. Furthermore, the electrically adjustable table system comprises a bus system 400, to which the two drives 321, 322, the operating part 330 as well as the bus port 55 of the power supply unit 50 are connected.

During operation of the assembly, the power supply unit 50 supplies the bus system 400 with a DC supply voltage, which serves for the power-related supply of the drives 321, 322. The DC supply voltage is approximately in the range of 20V to 40V and equals 30V, for example. Besides the DC supply voltage, control commands or signals, in particular bus control commands o signals can be transmitted via the bus system 400 as well, which are output by the operating part 330, for example, and received by the drives 321, 322. However, it is also possible that the two drives 321, 322 apply status messages of measured values of installed sensors to the bus system, which can be evaluated in the operating part, for example.

Of course, even other elements can be connected to the bus system 400, such as sensors of various types. For example, pressure or force sensors can be connected, which measure a load of the table. This can be used, inter alia, for known crush protection measures or the like.

For example, the bus port 55 is designed as a multi-pole plug, via which one or multiple other voltages or signals such as ultra-low voltages for supplying electronic components or control signals are also transmitted besides the DC supply voltage. One pole may also be used as a conductor for an operating state, for example, in particular a standby operating state, or a sleep mode, via which the power supply unit 50 can externally and partially or completely be cut-off from the power supply. This is effected via a corresponding operating mode signal, for example. The plug for the bus port 55 is designed as a customary Molex Microfit plug, for example.

The embodiment of the table system design illustrated in FIG. 4 allows a compact assembly with low cabling efforts, since the multiple socket outlet 100 with power supply unit 50 is connected to the power network via merely one power cable and no additional connections to the power network are required.

The power supply unit 50 can be connected to the bus system 400 in an entirely passive fashion. However, in various configurations, it is possible that the power supply unit 50 has provided corresponding electronics, which evaluates bus control signals from the bus system 400. This makes it possible, for example, that the power supply unit 50 is capable of controlling functions of the multiple socket outlet on the basis of bus control signals received via the bus port 55. This applies to switching individual sockets of the multiple socket outlet 100 on and off in a targeted manner, for example. This enables switching electric consumers at the workplace, for example.

In further embodiments, the multiple socket outlet 100 or the power supply unit 50 may also comprise a radio receiver for receiving radio control signals, depending on which functions of the multiple socket outlet 100 are controlled and/or control signals for the table system are given to the bus system 400. Such a radio receiver can be designed in accordance with a known radio standard such as Bluetooth or WLAN, for example, or comprise a proprietary high-frequency interface.

FIG. 5 shows another embodiment of a table system, which is essentially based upon the embodiment shown in FIG. 4. Besides the table 300 of FIG. 4, the table system comprises a further table 500, which, by way of example, also comprises a height-adjustable table plate 510, which is adjusted via respective drives 521, 522. Drives 521, 522 are connected to the common bus system 400, which is supplied with a DC supply voltage by the power supply unit 50. At the additional table 500, also another operating part 530 is provided, which, however, could also be omitted when operation of the tables 300, 500 is effected via operating part 330.

Thus, merely one individual power supply unit 50 is required for the entire table system. An additional cabling of the drive systems can be omitted, since everything can be effected via the existing bus system.

Power of the power supply unit 50 can be adapted to the required drive powers of the drives 321, 322, 521, 522. If both tables are to be adjusted at the same time, it is advantageous if the power of the power supply unit 50 is selected to be sufficiently high. However, if only one table is to be adjusted at a time, it is sufficient to adapt the output power of the power supply unit 50 to the requirements of one table. As a result, costs for the power supply unit 50 can be further reduced in such a table system.

Preferably, the used drives are capable of indicating a distinct adjustment process to the bus system 400 via a corresponding control signal. At the same time, the drives are advantageously capable of receiving and evaluating corresponding signals from the bus system 400 about an adjustment process of another drive. For example, a distinct adjustment process of one drive is prevented in the case that a control signal about an adjustment process of another table is received. For example, drives 321, 322 block one another when corresponding signals from drives 521 and/or 522 are received, and vice versa.

This principle can readily be expanded to a table system having three or more tables, when each of the individual drives know which drive belongs to the proper table and/or which drives belong to other tables.

The principle of a table system having multiple tables, a bus system and a common power supply unit with correspondingly low dimensioned power can naturally also be carried out with a separate power supply unit, which is not integrated in a multiple socket outlet.

In various embodiments, the bus system 400 may be formed with one single line for providing the DC supply voltage, or, if additionally a ground terminal is provided, one single conductor pair. The various bus signals, in particular control signals, are modulated on the DC supply voltage or coded otherwise, for example.

Preferably, however, the bus system is equipped with a higher number of lines. In addition to the line for the DC supply voltage and the line for a ground terminal, actually one line or one line pair for the transmission of control signals can be provided as well. For example, a transmission of these control signals is effected according to the known CAN bus standard, via which e.g. control signals can be transmitted between or to the electric drives. Additionally or alternatively, it is also possible to provide another control line or a control line pair, which are applied with a proprietary signal format or protocol, for example. For example, additionally or alternatively, members or participants can be connected to the bus system 400, that are not capable of coping with a general bus format such as the CAN bus format.

As an additional possible line, a line for the transmission of an operating mode signal can be provided in the bus system 400. In particular, it is favorable then when the power supply unit 50 is capable of evaluating this operating mode signal receivable via the bus port 55, as already described above. For example, one of multiple operating modes or operating states can be selected by the selection of a certain voltage level. In a normal operating state, the power supply unit 50 outputs full voltage or power, for example. Adjustment processes or other processes involving power requirement are performed in this operating state. For example, the DC supply voltage has its highest value in this operating state, for example approximately 30 V.

In a sleep mode, the table system is configured for a low energy consumption, for example, so that no adjustment processes are performed and possible displays of operating parts are switched-off, for example. Nevertheless, a basic voltage supply is maintained, which enables background activities of the connected members or participants, for example. For example, all members or participants connected to the bus system 400 are in an energy saving mode to keep the power consumption of the overall system at a level as low as possible. The DC supply voltage has a reduced value in this operating state, for example of approximately 10 V.

Besides the sleep mode, a third operating state, namely a deep-sleep mode, can also be provided, in which actually all components connected to the bus system 400 and which are supplied with power, are switched-off. In this case, merely an existing wake-up circuit of the power supply unit 50 is excluded, which ensures that the respective desired power is output to the bus system again in when correspondingly indicated via the operating mode signal. Since such wake-up circuits are generally known, the specific design thereof will not be explained in more detail. In this deep-sleep mode, no DC supply voltage is output from the power supply unit 50 to the bus system 400, respectively a DC supply voltage with a value of 0V.

1. A multiple socket outlet for an electrically adjustable table system, with a power supply unit for providing a DC supply voltage for the table system from a mains AC voltage, wherein the multiple socket outlet forms an integrated unit together with the power supply unit.

2. The multiple socket outlet according to claim 1,
wherein the power supply unit is arranged in a housing of the power supply unit, which can be fastened to the multiple socket outlet in a pluggable manner in such a way that the housing of the power supply unit and a housing of the multiple socket outlet form the integrated unit.

3. The multiple socket outlet according to claim 2,
wherein the housing of the power supply unit and the housing of the multiple socket outlet comprise respective mechanical connection elements and respective electric connection elements for the transmission of the mains AC voltage.

4. The multiple socket outlet according to claim 2,
wherein the housing of the power supply unit can be fastened at a side of the housing of the multiple socket outlet, where no sockets are provided for power plugs.

5. The multiple socket outlet according to claim 1,
wherein the power supply unit is integrated in a housing of the multiple socket outlet.

6. The multiple socket outlet according to claim 1,
wherein the DC supply voltage is provided via a bus port, via which the power supply unit can be connected to a bus system of the table system.

7. The multiple socket outlet according to claim 6,
wherein the power supply unit is configured to control functions of the multiple socket outlet based upon bus control signals received via the bus port.

8. The multiple socket outlet according to claim 6,
further comprising a radio receiver for receiving radio control signals, depending on which functions of the multiple socket outlet are controlled and/or control signals for the table system are given to the bus system.

9. An electrically-adjustable table system, comprising
a table;
at least one electric drive for adjusting the table;
an operating part;
a bus system, to which the at least one drive and the operating part are connected; and
a multiple socket outlet with a power supply unit for providing a DC supply voltage for the table system from a mains AC voltage via a bus port, wherein the multiple socket outlet forms an integrated unit together with the power supply unit, the multiple socket outlet being connected to the bus system via the bus port.

10. The table system according to claim 9,
further comprising at least one further table with at least one further electric drive for adjusting the at least one further table, wherein
the at least one further electric drive is connected to the bus system; and
the at least one electric drive and the at least one further electric drive are configured to indicate a distinct adjustment process to the bus system and to prevent a distinct adjustment process when receiving a signal from the bus system about an adjustment process of a drive of the respective other table.

11. The table system according to claim 10,
wherein an output power of the power supply unit is dimensioned to be lower than a sum of rated input powers of the electric drives connected to the bus system.

12. The table system according to claim 9,
wherein the power supply unit is configured to control functions of the multiple socket outlet based upon bus control signals received via the bus port.

13. The table system according to claim 9,
further comprising a radio receiver for receiving radio control signals, depending on which functions of the multiple socket outlet are controlled and/or control signals for the table system are given to the bus system.
